(19) United States
(12) Patent Application Publication
(10) Pub. No.: US 2020/0217437 A1
(43) Pub. Date: Jul. 9, 2020

(54) ROTARY JOINT

(71) Applicant: Deublin Company, Waukegan, IL (US)

(72) Inventors: Anton A. Petrou, Hawthorn Woods, IL (US); David Burrus, Chicago, IL (US)

(21) Appl. No.: 16/241,581

(22) Filed: Jan. 7, 2019

(51) Int. Cl. F16L 27/087; F16L 27/08; F16J 15/00; F16J 15/3212; F16J 15/34

(52) U.S. Cl. CPC F16L 27/087; F16L 27/0816; F16J 15/3452; F16J 15/3212; F16J 15/002

(57) ABSTRACT

A rotor including an internal fluid opening extending in a radial direction through the rotor and two ring seals disposed in opposed orientation on the rotor. Each of the two ring seals sealably and slidably engages the rotor. A stator is disposed around the rotor and the two ring seals and forms an external fluid opening extending in the radial direction through the stator. The stator includes two ring flanges disposed at axially distal ends thereof. Each of the two ring seals slidably contacts a respective one of the two ring flanges to form a mechanical sliding face seal.

### TECHNICAL FIELD OF THE DISCLOSURE

The present invention relates to rotary devices such as rotary unions, swivel unions, slip rings and the like.

### BACKGROUND OF THE DISCLOSURE

Fluid coupling devices such as rotary unions or rotary joints are used in various applications such as industrial applications, for example, machining of metals or plastics, work holding, printing, plastic film manufacture, papermaking, and other industrial processes that require a fluid medium to be transferred from a stationary source such as a pump or reservoir into a rotating element such as a machine tool spindle, work-piece clamping system, or rotating drums or cylinder. Additional types of application include use on vehicles, for example to inflate tires during vehicle motion, or to transfer pneumatic or hydraulic fluid into a rotating shaft to activate a propeller pitch adjustment device on a marine application. Often these applications require relatively high media pressures, flow rates, or high machine tool rotational speeds.

One example of a rotary joint can be seen in U.S. Pat. No. 7,407,198 to Ott et al. (“Ott”), which describes a radial rotary transfer assembly. In the device of Ott, a ring-shaped rotor and stationary part include sealing rings therebetween to seal a fluid passage extending through the stationary part and into a shaft disposed within the rotor. While the radial rotary transfer assembly of Ott is at least partially effective in providing a fluid seal between a rotating shaft and a stationary part, its arrangement requires disassembly and/or reassembly, e.g., during service, from one side of the shaft, and further requires cutouts in its sealing rings to prevent their rotation while the rotor is rotating.

### BRIEF SUMMARY OF THE DISCLOSURE

The disclosure describes, in one aspect, a rotary joint. The rotary union includes a rotatable assembly adapted for mounting onto a shaft. The rotatable assembly includes an internal fluid opening extending in a radial direction through the rotatable assembly, and two ring seals disposed in opposed orientation on a rotor. Each of the two ring seals is sealably engaged on the rotor and slidable relative to the rotor in an axial direction, which is perpendicular to the radial direction. A non-rotatable assembly is disposed around the rotatable assembly and forms an external fluid opening extending in the radial direction through the non-rotatable assembly. The non-rotatable assembly includes two ring flanges disposed at axially distal ends thereof. Each of the two ring seals slidably contacts a respective one of the two ring flanges to form a mechanical sliding face seal. A radial gap is defined between the rotatable and non-rotatable assemblies. The radial gap is sealed in an axial direction, at least in part, by the mechanical sliding face seals between the two ring seals and the two ring flanges.

In another aspect, the disclosure describes a rotary joint, which includes a rotor adapted for mounting onto a shaft, the rotor including an internal fluid opening extending in a radial direction through the rotor, and two ring seals disposed in opposed orientation on the rotor, each of the two ring seals being sealably engaged on the rotor and slidable relative to the rotor in an axial direction, which is perpendicular to the radial direction. The rotary joint further includes a stator disposed around the rotor and the two ring seals, the stator forming an external fluid opening extending in the radial direction through the stator, the stator including two ring flanges disposed at axially distal ends thereof. Each of the two ring seals slidably contacts a respective one of the two ring flanges to form a mechanical sliding face seal. A radial gap is defined between the rotor and the stator. The radial gap is sealed in an axial direction, at least in part, by the mechanical sliding face seals between the two ring seals and the two ring flanges.

In yet another aspect, the disclosure describes a method for operating a rotary joint. The method includes providing a rotor mounted onto a shaft, the rotor including an internal fluid opening extending in a radial direction through the rotor and fluidly communicating with a fluid passage in the shaft; providing two ring seals disposed in opposed orientation on the rotor, each of the two ring seals being sealably engaged on the rotor and slidable relative to the rotor in an axial direction, which is perpendicular to the radial direction; providing a stator disposed around the rotor and the two ring seals, the stator forming an external fluid opening extending in the radial direction through the stator, the stator including two ring flanges disposed at axially distal ends thereof; slidably contacting a respective one of the two ring flanges with each of the ring seals to form a mechanical sliding face seal; and biasing the two ring flanges away from one another and towards the ring flanges.

### BRIEF DESCRIPTION OF THE SEVERAL VIEWS OF THE DRAWINGS

FIG. 1 is an outline view of a rotary joint in accordance with the disclosure.

FIG. 2 is a section view through a portion of the rotary joint of FIG. 1.

FIG. 3 is a partially disassembled view of the rotary joint of FIG. 1 to illustrate internal structures thereof.

FIGS. 4 and 5 are outline views from different perspectives of a sealing ring for use in the rotary joint of FIG. 1.

FIG. 6 is an enlarged, partially sectioned view and pressure diagram of an alternative embodiment of a rotary joint in accordance with the disclosure.

FIG. 7 is a section view of an alternative embodiment for a rotary joint in accordance with the disclosure.

### DETAILED DESCRIPTION

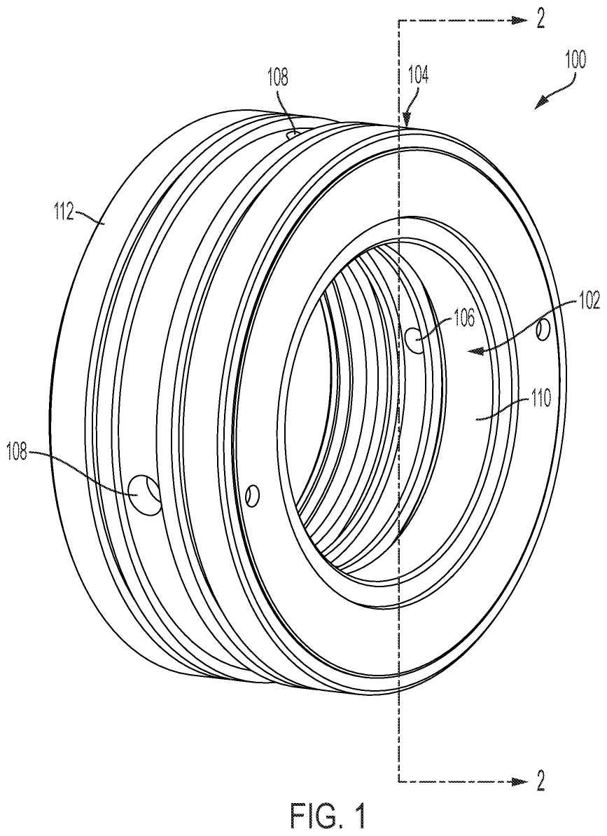

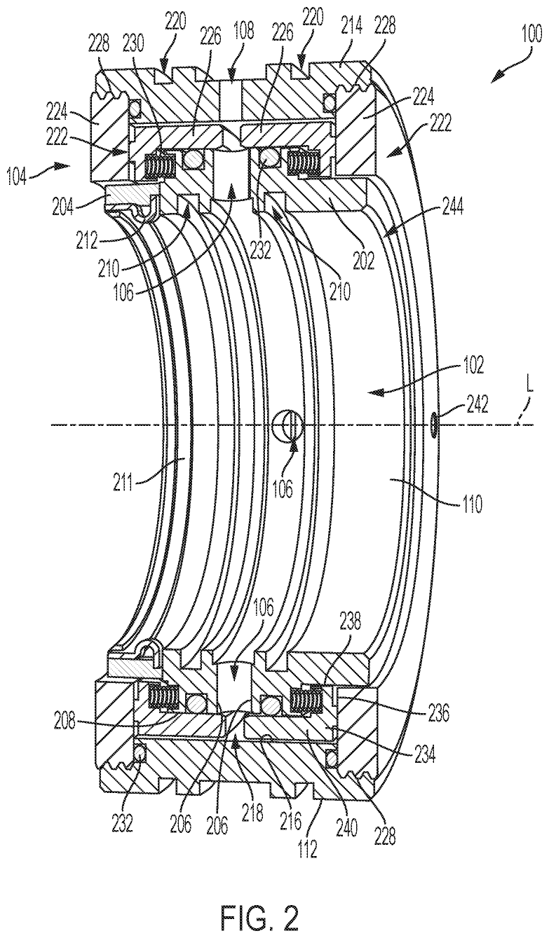

In the drawings, which form a part of this specification, FIG. 1 shows an outline view of a rotary joint 100 in accordance with the disclosure, and FIG. 2 shows a section view of the rotary joint 100 to illustrated internal structures thereof. In reference to these figures, the rotary joint 100 generally includes a rotatable assembly 102 having a generally cylindrical shape that is rotatably disposed within a non-rotatable assembly 104. It should be appreciated that the terms “rotatable” and “non-rotatable” are used for sake of discussion and should not be construed as a limitation on the function of the assemblies. For example, depending on the application, the rotatable assembly 102 may remain stationary while the non-rotatable assembly 104 is configured to rotate around the rotatable assembly 102 during operation. Moreover, in certain applications, either or both of the assemblies 102 and 104 may rotate or swivel by an angular displacement that is less than a full rotation. In general, therefore, the terms are used to denote the various components that are rotatably engaged with each other, without regard to the actual operational motion thereof. In the illustrated, exemplary embodiment, the rotatable assembly 102 is configured to be rotatably engaged such that it rotates with a propeller shaft of a marine vehicle (not shown), and the non-rotatable assembly 104 is configured to be mounted onto a hull of the marine vehicle (not shown) and, in being so mounted, remain stationary with the hull while the propeller shaft is rotating.

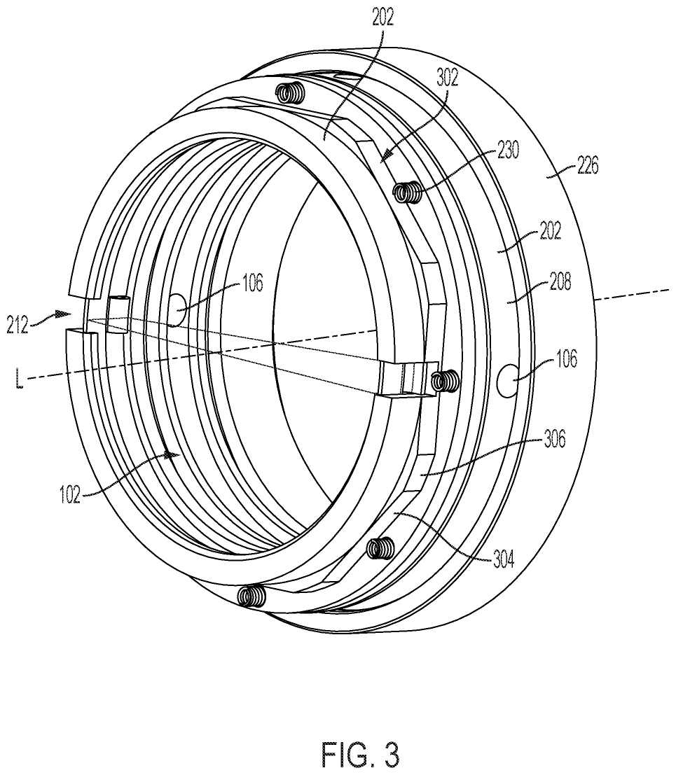

As can be seen from the outline view of FIG. 1, one or more internal fluid openings 106 are formed along an inner surface 110 of the rotatable assembly 102, which is adapted to be disposed around a portion of the propeller shaft, and one or more external fluid openings 108 are formed along an external surface 112 of the non-rotatable assembly 104. During operation, fluid can be sealably conveyed between the internal and external fluid openings 106 and 108 while the rotatable assembly 102 is rotating with respect to the non-rotatable assembly 104 (or vice versa). Sealing of the fluid transfer between the internal and external fluid openings 106 and 108 is accomplished by use of sealing rings providing sliding mechanical face seals, as can be seen more clearly in the cross section of FIG. 2. In reference to FIG. 2, it can be seen that the rotatable assembly 102 includes a rotor 202 having an inner sleeve 204. The inner sleeve 204 has a generally hollow cylindrical or tubular shape that extends axially along a longitudinal axis, L. The rotor 202 further includes a radial wall 206, which extends radially outwardly with respect to the longitudinal axis L. The radial wall 206 forms the one or more internal fluid openings 106, each of which extends in the radial direction through the rotor 202 to fluidly connect the inner surface 110 with an outer surface 208 of the radial wall 206 (also shown in FIG. 3).

When the rotary joint 100 is installed on a shaft (not shown), the inner sleeve 204 is disposed with a clearance fit around an outer surface of the shaft and overlaps a section thereof that may include fluid openings, for example, for supplying hydraulic fluid to operate a pitch control mechanism of propeller blades (not shown). To seal against leakage of fluid at the inner surface 110, the inner sleeve 204 includes two radial seal grooves 210 disposed axially on either side of the internal fluid openings 106 along the inner surface 110. In the illustrated embodiment, an anti-rotation collar 211, which includes notches 212 that matingly engage with corresponding cutouts or keyways formed in the exterior of the shaft (not shown), rotatably engages the rotor 202 with the rotating shaft (not shown).

The non-rotatable assembly 104 includes a stator 214, which has a generally hollow cylindrical shape and surrounds the rotor 202 in the radial direction. The stator 214 forms the external fluid openings 108, which extend in the radial direction through the stator 214 to fluidly connect the external surface 112 with an internal surface 216 of the stator 214. As can be seen from FIG. 2, an open space or radial gap 218 exists between the outer surface 208 of the rotor 202 and the internal surface 216 of the stator 214 that can communicate fluids between the internal and external fluid openings 106 and 108. The radial gap 218 extends peripherally around the stator 214 and rotor 202 such that fluid may communicate regardless of the rotational orientation or motion between the rotor 202 and stator 214. Fluid from the external fluid openings 108 can be communicated to other components such as a hollow sleeve (not shown), and can be sealed with radial seals (not shown) disposed in grooves 220, or may alternatively be provided into a fitting (not shown) installed directly onto or into the openings 108 in the typical fashion.

To prevent leakage of fluid passing through the radial gap 218, the rotary joint 100 includes two mechanical face seals 222 disposed axially relative to the longitudinal axis L on either side of the radial gap 218. Each face seal 222 has an annular shape and slidingly contacts the two opposed ring flanges 224 and two opposed ring seals 226. In the embodiment shown in FIG. 2, the ring flanges 224 are connected to the two axial ends and are disposed radially within the stator 214. As shown, threads 228 engage the ring flanges 224 to the stator 214, which permits the removal of each ring flange 224 for service, but other mounting arrangements can also be used.

The ring seals 226 are placed in opposing orientation and form part of the rotatable assembly 102. In the embodiment shown in FIG. 2, the ring seals 226 are slidably disposed on the rotor 202 and permitted to slide in the axial direction along the longitudinal axis L. Springs 230 are disposed between the rotor 202 and the ring seals 226 and bias the ring seals 226 away from the rotor 202 and from one another and towards the respective ring flanges 224. Radial seals 232 are disposed between the stator 214 and the ring flanges 224, and also between the rotor 202 and the ring seals 226 to complete the sealing of the radial gap 218.

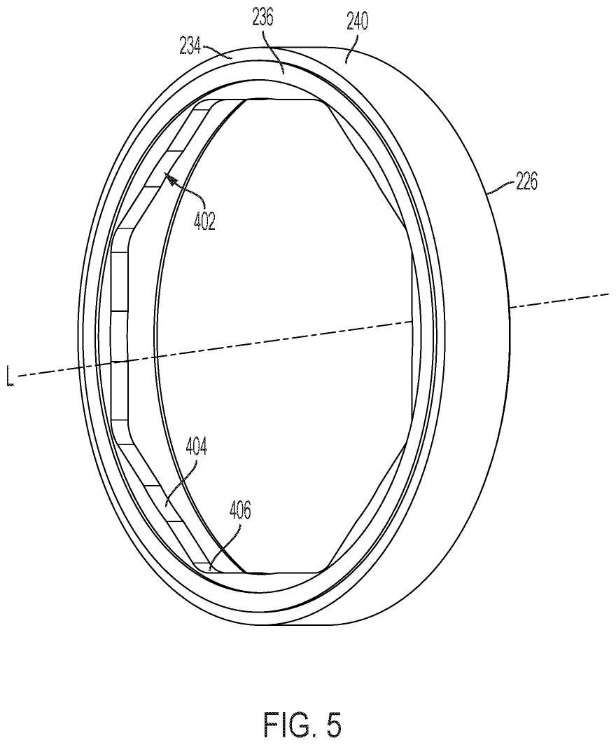

In the exemplary embodiment shown in FIG. 2, and also in reference to FIG. 5, which shows a ring seal 226 removed from the rotary joint 100, each ring seal 226 includes an outer annular face 234 extending in the radial direction. The outer annular face 234 includes a raised portion 236 that protrudes in the axial direction away from the annular face 234. The raised portion 236 contacts and slides against an inner annular face 238 of the respective ring flange 224 to form the sliding mechanical face seal 222 on either side of the rotary joint 100. The outer annular face 234 extends from a cylindrical body 240 of each ring seal 226. The cylindrical body 240 provides the surfaces that slidably and sealably engage the radial wall 206 of the rotor 202 via the radial seal 232.

For assembling the rotary joint 100 between a shaft (not shown) and a static receiver (also not shown), the rotor 202 can be installed around a section of the shaft, followed by the ring seals 226 on either side of the rotor 202. The stator 214 can then be placed around the ring seals 226 and the ring flanges 224 installed on either side. For installing the ring flanges, openings 242 may be formed externally thereto to permit engagement with a tool (not shown). Chamfers 244 may be formed on the inner, leading and trailing edges of the rotor 202 to facilitate installation onto a shaft.

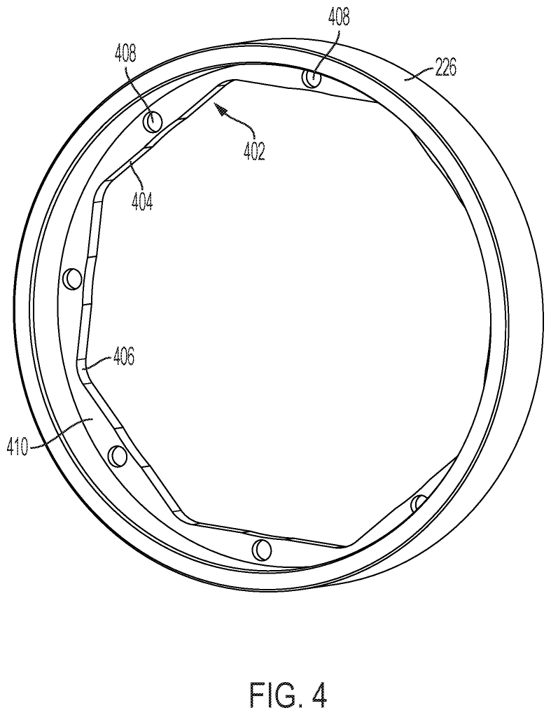

As discussed above, the ring seals 226 are rotatably engaged to rotate (or not rotate) with the rotor 202 and form part of the rotatable assembly 102. The rotatable engagement between the ring seals 226 and the rotor 202 can be accomplished in various ways such as keyed arrangements, splines and the like. In the illustrated embodiment, and as shown in FIGS. 3 and 4, an octagonal interface is used between the rotor 202 and each ring seal 226. As shown in FIG. 3, which is a partially disassembled rotatable assembly 102 in which a ring seal 226 has been removed, the rotor 202 forms a male octagonal section 302 which includes symmetrically arranged inclined faces 304 and shoulders 306. The inclined faces 304 are generally oriented to coincide with the springs 230, which are also symmetrically spaced. The male octagonal section 302 matingly engages with a female octagonal section 402 formed internally in the ring seal 226, as shown in FIG. 5. The female octagonal section 402 includes inclined portions 404 that mate with the inclined faces 304, and corner portions 406 that accommodate the shoulders 306. As can be seen from this view, indentations 408 formed on an inner surface 410 of the female octagonal section 402 accommodate and retain the ends of the springs 230.

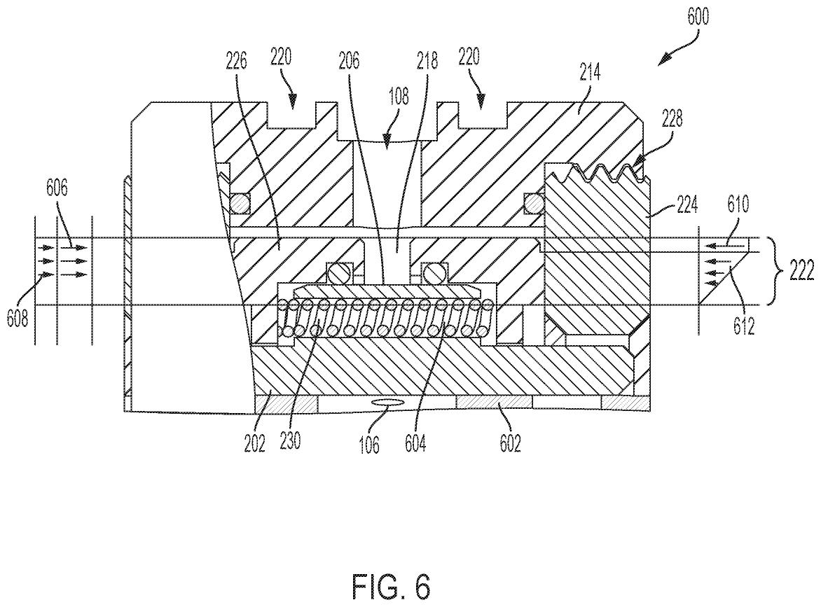

An enlarged cross section of an alternative embodiment of a rotary joint 600 is shown in FIG. 6. Also in this illustration, operating pressures on certain sections of the mechanical face seals 222 are shown for sake of discussion. In the embodiment shown in FIG. 6, structures and features of the rotary joint 600 that are the same or similar to corresponding structures and features of the rotary joint 100 are denoted by the same reference numerals previously used for simplicity. Also in this illustration, operating pressures on certain sections of the mechanical face seals 222 are shown for sake of discussion.

In the embodiment shown in FIG. 6, structures and features of the rotary joint 600 that are the same or similar to corresponding structures and features of the rotary joint 100 are denoted by the same reference numerals previously used for simplicity. In reference to FIG. 6, it can be seen that the rotor 202 is disposed onto a shaft 602. The spring 230, rather than being made from two separate spring sections disposed on either side of the radial wall 206 (FIG. 2), is made from a single spring section that extends through a bore 604 formed axially through the radial wall 206. In its installed position, the spring 230 may be placed in compression and thus apply a restorative force equally on both ring seals 226 tending to push them apart and against the ring flanges 224. With respect to the ring seal 226 shown on the right side of FIG. 6, various forces acting on the sliding mechanical face seal 222 are illustrated.

If friction or other external forces and accelerations that may act on the ring seal 226 in its operating environment are disregarded, for sake of discussion, in the presence of a fluid under pressure within the radial gap 218, a hydraulic closing force 606 may act on the ring seal 226 as the seal's closing hydraulic surfaces are exposed to fluid pressure. It is noted that, for the seal on the right of FIG. 6, a closing hydraulic force is in the direction towards the right, i.e., a force tending to push the ring seal 226 towards and against the ring flange 224. Also acting in the closing direction is a spring force 608, which results from the restoration force of the compressed spring 230 onto the ring seal 226.

In the opposite, opening direction, which for the ring seal 226 discussed here is towards the left or away from the ring flange 224, a hydraulic opening force 610 acts on the ring seal 226 as the seal's opening hydraulic surfaces are exposed to fluid pressure. A seal pressure 612, which has a linear profile for incompressible fluids, or a curved profile for compressible fluids, acts along the mechanical face seal 222. If the spring force 608 is not taken into account, the ratio of the opening hydraulic forces over the closing hydraulic forces can define a balance ratio, B, for the ring seal 226, which can be selected to be equal to one (B=1) for a transitional seal, less than one (B<1) for a stable seal, and more than one (B>1) for an unstable seal. In the illustrated embodiment, the balance ratio is less than 85% but other ratios may be used depending on the type of fluid used, the operating pressures, whether an opening, closing or no spring is used, the type of spring and value of spring constant, and other parameters. For example, a larger contact area between sliding surfaces in the mechanical face seal 222 may decrease the balance ratio and, likewise, a smaller contact area can increase the balance ratio.

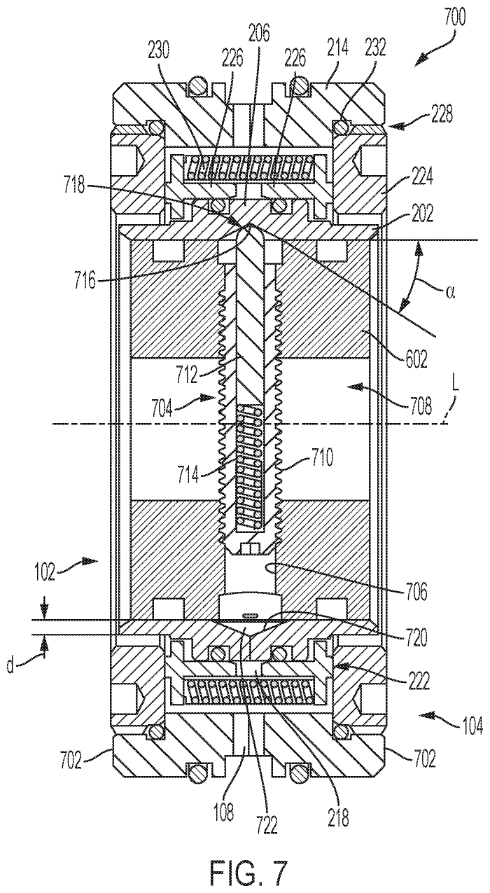

A cross section of an alternative embodiment for a rotary joint 700 is shown in FIG. 7. In this illustration, structures and features that are the same or similar to corresponding structures and features already described for other embodiments are denoted by the same reference numerals as previously used for simplicity. In reference to FIG. 7, alternative structures for mounting the rotor 202 onto the shaft 602, for sealing the ring flanges 224 onto the stator 214, and for mounting the spring 230 between the two opposed ring seals 226 are shown.

More specifically, the threaded connection 228 between the ring flanges 224 and the stator 214, unlike the embodiment shown in FIG. 2, where the threads 228 axially extend an entire length of the ring flanges 224, in the embodiment shown in FIG. 7, the threads 228 extend from the axial end faces 702 of the stator 214 inwardly for a length that is less than a plate thickness of the ring flanges 224 in the axial direction, L, which leaves the radial seals 232 and the corresponding groove to accommodate them that is formed in the material of the stator 214 to enclose the radial seals 232 from three sides, that is, their radial outward side and also the axially inward and outward sides. The radial seals 232 are thus contacting a radially outward and axially inward edge of the ring flanges 224, which improves their sealing function in that the outer diameter, rather than the final, installed axial location of the ring flanges 224, determine the compression of the seals 232.

With respect to spring placement, as can be seen in FIG. 7, the radial wall 206 of the rotor 202 is considerably shorter than the wall in the embodiment of FIG. 2, which increases the radial distance of the radial gap 218. In this way, the spring 230 (also see FIG. 6) is disposed between the two ring seals 226 without being accommodated within a guide opening or indentation 408 (see FIG. 4) or within a bore 604 (see FIG. 6) of the rotatable assembly 102. This simplifies installation of the rotatable assembly components and reduces complexity in the rotor 202.

Finally, for installing the rotor 202 onto the shaft 602, the anti-rotation collar 211 and notches 212 (FIG. 2) are replaced by a spring-loaded pin fastener 704 that is installed within a threaded bore 706 formed through the shaft 602. In reference to the embodiment shown in FIG. 7, the threaded bore 706 extends diametrically across a section of the shaft 602 and intersects a fluid channel 708 extending through the shaft 602. The bore threadably engages the fastener 704 which includes an outer threaded section 710 that slidably accepts therein a pin 712. The pin 712 is outwardly biased by a spring 714 such that a tip 716 extends radially outwardly with respect to an outer diameter of the shaft 602.

When the rotor 202 is installed onto the shaft 602, either singularly or with the remaining components of the rotary joint 700 assembled thereon, the rotor 202 is slid along the shaft 602 until it overlaps the tip 716 of the pin 712. Upon continued motion of the rotor 202, the tip retracts compressing the spring until an axial position in which a ramped notch 718 passes over the tip 716, allowing the tip 716 to extend into the ramped notch 718. The ramped notch 718 has a generally U-shape with slanted axial faces or ramps 720 on either axial end that define a concave depression that faces inwardly. The ramps 720 allow disassembly of the rotor 202 when axially moved along the shaft 602 by causing a compression of the spring 714 and retraction of the tip 716 as the tip 716 follows the ramps 720.

While the tip 716 of the pin 712 is disposed within the notch 718, side faces 722 that are planar and extend parallel to the longitudinal axis L push sideways (into or out from the page in the orientation shown in FIG. 7) to rotatably engage the rotor 202 with the shaft 602 via interference between the side faces 722 with the pin 712. The radial depth, d, of the ramped notch 718 and the angle, a, of the ramps relative to the longitudinal axis can be selected to appropriately transmit an expected torque to the rotor 202 without shearing off the tip 716 during operation.

In reference to FIG. 6, it can be seen that the rotor 202 is disposed onto a shaft 602. The spring 230, rather than being made from two separate spring sections disposed on either side of the radial wall 206 (FIG. 2), is made from a single spring section that extends through a bore 604 formed axially through the radial wall 206. In its installed position, the spring 230 may be placed in compression and thus apply a restorative force equally on both ring seals 226 tending to push them apart and against the ring flanges 224. With respect to the ring seal 226 shown on the right side of FIG. 6, various forces acting on the sliding mechanical face seal 222 are illustrated.

All references, including publications, patent applications, technical documentation and user manuals, patents, and other material cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A rotary joint, comprising:
a rotatable assembly adapted for mounting onto a shaft, the rotatable assembly including an internal fluid opening extending in a radial direction through the rotatable assembly, the rotatable assembly including two ring seals disposed in opposed orientation on a rotor, each of the two ring seals being sealably engaged on the rotor and slidable relative to the rotor in an axial direction, which is perpendicular to the radial direction;
a non-rotatable assembly disposed around the rotatable assembly, the non-rotatable assembly forming an external fluid opening extending in the radial direction through the non-rotatable assembly, the non-rotatable assembly including two ring flanges disposed at axially distal ends thereof;
wherein each of the two ring seals slidably contacts a respective one of the two ring flanges to form a mechanical sliding face seal;
wherein a radial gap is defined between the rotatable and non-rotatable assemblies; and
wherein the radial gap is sealed in the axial direction, at least in part, by the mechanical sliding face seals between the two ring seals and the two ring flanges.

2. The rotary joint of claim 1, wherein the rotor further includes a radial wall, wherein the internal fluid opening extends through the radial wall, and wherein the two ring seals are slidably sealed in the axial direction with respect to the radial wall.

3. The rotary joint of claim 1, wherein each of the two ring flanges is attached to a stator, the stator having a generally hollow cylindrical shape.

4. The rotary joint of claim 3, further comprising mating threads in the two ring flanges and the axially distal ends of the stator, wherein the two ring flanges are threadably engaged onto the stator.

5. The rotary joint of claim 1, further comprising a plurality of compression springs disposed to impose a force biasing the two ring seals away from one another and towards the two ring flanges.

6. The rotary joint of claim 1, wherein the rotor includes a male section having inclined surfaces and shoulders, wherein each of the two ring seals includes a female section having inclined portions and corner portions, and wherein the female section matingly engages the male section when the two ring seals are disposed on the rotor such that the two ring seals are rotatably engaged to rotate with the rotor.

7. The rotary joint of claim 1, further comprising an anti-rotation device embodied as one of a collar associated with the rotatable assembly, the anti-rotation collar including one or more notches adapted to engage corresponding slots in the shaft such that the rotatable assembly rotates with the shaft, or as a spring-loaded pin extending outwardly from the shaft and engaging a ramped notch formed in the rotor.

8. The rotary joint of claim 1, wherein, during operation, the rotatable assembly is configured to rotate relative to the non-rotatable assembly, which is stationary.

9. The rotary joint of claim 1, wherein, during operation, the non-rotatable assembly is configured to rotate relative to the rotatable assembly, which is stationary.

10. A rotary joint, comprising:
a rotor adapted for mounting onto a shaft, the rotor including an internal fluid opening extending in a radial direction through the rotor;
two ring seals disposed in opposed orientation on the rotor, each of the two ring seals being sealably engaged on the rotor and slidable relative to the rotor in an axial direction, which is perpendicular to the radial direction;
a stator disposed around the rotor and the two ring seals, the stator forming an external fluid opening extending in the radial direction through the stator, the stator including two ring flanges disposed at axially distal ends thereof;
wherein each of the two ring seals slidably contacts a respective one of the two ring flanges to form a mechanical sliding face seal;
wherein a radial gap is defined between the rotor and the stator; and
wherein the radial gap is sealed in the axial direction, at least in part, by the mechanical sliding face seals between the two ring seals and the two ring flanges.

11. The rotary joint of claim 10, wherein the rotor further includes a radial wall, wherein the internal fluid opening extends through the radial wall, and wherein the two ring seals are slidably sealed in the axial direction with respect to the radial wall.

12. The rotary joint of claim 10, wherein the stator having a generally hollow cylindrical shape.

13. The rotary joint of claim 10, further comprising mating threads in the two ring flanges and the axially distal ends of the stator, wherein the two ring flanges are threadably engaged onto the stator.

14. The rotary joint of claim 10, further comprising a plurality of compression springs disposed to impose a force biasing the two ring seals away from one another and towards the two ring flanges.

15. The rotary joint of claim 10, wherein the rotor includes a male section having inclined surfaces and shoulders, wherein each of the two ring seals includes a female section having inclined portions and corner portions, and wherein the female section matingly engages the male section when the two ring seals are disposed on the rotor such that the two ring seals are rotatably engaged to rotate with the shaft.

16. The rotary joint of claim 10, further comprising an anti-rotation structure such that the rotor and the two ring seals rotate with the shaft.

17. A method for operating a rotary joint, comprising:
providing a rotor mounted onto a shaft, the rotor including an internal fluid opening extending in a radial direction through the rotor and fluidly communicating with a fluid passage in the shaft;
providing two ring seals disposed in opposed orientation on the rotor, each of the two ring seals being sealably engaged on the rotor and slidable relative to the rotor in an axial direction, which is perpendicular to the radial direction;
providing a stator disposed around the rotor and the two ring seals, the stator forming an external fluid opening extending in the radial direction through the stator, the stator including two ring flanges disposed at axially distal ends thereof;
slidably contacting a respective one of the two ring flanges with each of the two ring seals to form a mechanical sliding face seal; and
biasing the two ring flanges away from one another and towards the two ring flanges.

18. The method of claim 17, further comprising providing a radial wall on the rotor, and slidably sealing the two ring seals relative to the radial wall.

19. The method of claim 17, further comprising releasably attaching each of the two ring flanges onto axial distal ends of the stator.

20. The method of claim 17, further comprising providing a male section having inclined surfaces and shoulders on the rotor, providing a female section having inclined portions and corner portions on the two ring seals, and matingly engaging the female section around the male section such that the two ring seals are rotatably engaged to rotate with the shaft.
